(19) United States
(12) Patent Application Publication
(10) Pub. No.: US 2004/0199899 A1
(43) Pub. Date: Oct. 7, 2004

(54) System and method for determining whether a mix of system components is compatible

(76) Inventors: Richard Dickert Powers, Highland Village, TX (US); Scott Lynn Michaelis, Plano, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/408,016

(22) Filed: Apr. 4, 2003

(51) Int. Cl. G06F 9/44

(52) U.S. Cl. 717/120; 717/168

(57) ABSTRACT

In accordance with one embodiment of the present invention, a method comprises identifying a plurality of components on a system. The method further comprises accessing with system firmware a compatibility structure that includes information indicating whether each of the plurality of components are compatible with each other, wherein the compatibility structure is arranged external to the system firmware. The method further comprises determining with the system firmware based at least in part on the information of the compatibility structure whether the identified plurality of components are compatible with each other.

### BACKGROUND

The complexity, capacity, and intelligence of computer systems is ever evolving. Further, various components that may be implemented within a computer system are continually being changed and/or modified. For instance, processor developers are continually releasing newer revisions of their processors. As another example, developers of various other components of a computer system, such as memory, controllers, other hardware components, operating systems, and other software applications, are continually releasing newer revisions of those components.

Various mixes (or combinations) of components may not be compatible with one another on a system. For instance, suppose a processor developer releases a first processor, then later releases a first revision of such processor, and then later releases a second revision of the processor. Further suppose that a customer desires to implement a plurality of processors within his/her system. Certain mixes of the processors may be compatible with each other for being combined within the system, while other mixes may not be compatible. Continuing with the above example, for instance, the first processor release and the first revision of such processor may be compatible with each other, whereas the first processor release and the second revision of such processor may not be compatible with each other.

It is generally desirable to recognize whether existing components of a system are compatible. Thus, generally system firmware is implemented that is responsible for identifying the components on a system and verifying that such components are compatible during boot-up of the system. If the components are compatible, then the firmware allows the system to boot-up. If, however, the firmware determines that the components of the system are incompatible, the firmware may not allow the system to boot-up and may instead provide a warning of the incompatible components. If the system were allowed to boot and proceed with operation with incompatible components, problems may be encountered later, such as data corruption, etc., and such problems may not be identified until they have become very serious (e.g., the problems may not be immediately apparent to a user).

### SUMMARY

In accordance with one embodiment of the present invention, a method comprises identifying a plurality of components on a system. The method further comprises accessing with system firmware a compatibility structure that includes information indicating whether each of the plurality of components are compatible with each other, wherein the compatibility structure is arranged external to the system firmware. The method further comprises determining with the system firmware based at least in part on the information of the compatibility structure whether the identified plurality of components are compatible with each other.

In accordance with another embodiment of the present invention, a system comprises a means for identifying, during a boot-up process of a system, a mix of components implemented on the system, and a means for storing compatibility information indicating whether a plurality of different mixes of components are compatible with each other. The system further comprises a means for determining, based at least in part on the compatibility information, whether the mix of components identified by the identifying means are compatible with each other, wherein the compatibility information of the compatibility structure is modifiable without requiring modification to the determining means.

In accordance with another embodiment of the present invention, a system comprises firmware stored to a first portion of non-volatile memory and operable to discover a plurality of different components implemented on a computer system. The system further comprises a compatibility structure stored to a second portion of non-volatile memory different from the first portion and communicatively accessible by the firmware, wherein the compatibility structure comprises information indicating whether different components are compatible with each other. The firmware is further operable to determine, based at least in part on the information of the compatibility structure, whether the plurality of different components discovered by the firmware are compatible with each other.

In accordance with another embodiment of the present invention, computer-executable software code stored to a computer-readable media is provided. The computer-executable software code comprises code for identifying a plurality of components on a system. The computer-executable software code further comprises code included in system firmware for accessing a compatibility structure that includes information indicating whether each of the plurality of components are compatible with each other, wherein the compatibility structure is arranged external to the system firmware. The computer-executable software code further comprises code included in the system firmware for determining based at least in part on the information of the compatibility structure whether the identified plurality of components are compatible with each other.

In accordance with another embodiment of the present invention, a method for preventing a new component from causing compatibility errors on at least one existing computer system in which it is used is provided. The method comprises testing the new component for compatibility with mixes of other components. The method further comprises using results of the testing to generate compatibility information indicative of any incompatible combinations of the new component and the mixes of other components, the compatibility information being useable by firmware of the computer to preclude computer operation in any of the incompatible combinations. The method further comprises making the compatibility information accessible to the firmware of the computer system without modification to the firmware.

### BRIEF DESCRIPTION OF THE DRAWINGS

FIG. 1 shows an example system implementing an embodiment of the present invention;

FIG. 2 shows an example compatibility structure that may be implemented in embodiments of the present invention;

FIGS. 3A-3B show a further example of implementing a compatibility structure in accordance with an embodiment of the present invention;

FIG. 4 shows a further example of implementing a compatibility structure in accordance with an embodiment of the present invention;

FIG. 5 shows an example operational flow diagram illustrating the operation of one embodiment of the present invention; and

FIG. 6 shows an example operational flow diagram for updating a compatibility structure such that system firmware can check for the compatibility of a newly released component with mixes of other components in accordance with an embodiment of the present invention.

### DETAILED DESCRIPTION

Various embodiments of the present invention are now described with reference to the above FIGURES. As mentioned above, it is generally desirable to recognize whether existing components of a system are compatible. Traditionally, system firmware has been implemented for identifying the components on a system and verifying that such components are compatible during boot-up of the system. However, particularly as the frequency at which newer components are released increases, it becomes undesirable to require a new release of system firmware each time that a new component is released in order for the system firmware to be capable of determining the compatibility of component mixes that include such newly released component. That is, it becomes undesirable to require a new release of system firmware upon the release of a new component (e.g., new processor revision or “stepping”) such that the firmware has the added functionality of determining the compatibility of the newly released component with a mix of other components in a system. Such a release of system firmware is disruptive to customers, and thus customers generally do not like to install new system firmware in their systems.

Of course, some releases of new components may dictate that new system firmware be developed to be able to interface with such components, for example. However, in many cases a release of a new component is transparent (or nearly transparent) to external devices from that of earlier versions of the component. For example, a processor may be initially released by a developer. Later, the developer may discover a more efficient (or otherwise desirable) manufacturing process (e.g., different chip layout, etc.) to use in manufacturing the initial processor, and thus may begin releasing a first revision (or first “stepping”) of the processor using this different manufacturing process (e.g., different chip layout). As is well-known in the art, revisions of processors are commonly referred to as “steppings”, and thus the term “stepping” is used herein in the manner that it is commonly used in the art. Although the first revision of the processor in the above example may be practically the same in its operation as the initially released processor, the developer will generally assign a different “stepping” to the processors developed with the new manufacturing process so that if errors are later detected with the processors it may be easier to determine the cause of such errors. In some instances, the processor may be revised such that its operation is improved in some manner (e.g., the chip frequency is increased, the on-chip cache size is increased, etc.). Often, such revisions are implemented such that the processor may be used exactly as the earlier version of the processor (e.g., at a slower chip frequency), but provide the benefit of being able to provide the improved performance if/when desired (e.g., provide the increased frequency).

Particularly in instances in which a newly released component (e.g., a new processor stepping) does not require a change in system firmware other than for the system firmware to be capable of determining mixes of other components with which the newly released component is compatible (e.g., changes to the newly released component over an earlier released version of the component are virtually transparent to external devices), it is undesirable to require a new release of system firmware. As described further below, embodiments of the present invention provide a compatibility structure that may be implemented within a system and used by system firmware for determining the compatibility of various component mixes that may be implemented within the system. According to certain embodiments, such compatibility structure is capable of being edited without requiring any modification to the system firmware itself. Accordingly, upon new components being released (e.g., new processor steppings), the compatibility structure may be updated to reflect the proper component mixes that are compatible with the newly released component without requiring the system firmware to be modified and/or re-installed on the system.

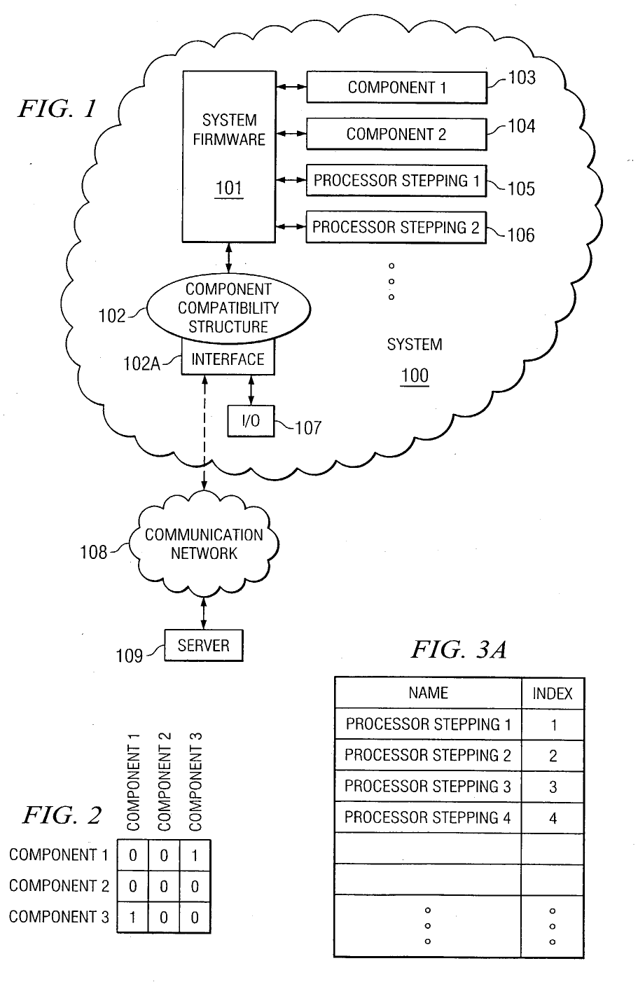

Turning to FIG. 1, an example system 100 implementing an embodiment of the present invention is shown. As shown, system 100 comprises system firmware 101, as well as various components, such as component 1 (labeled 103), component 2 (labeled 104), processor stepping 1 (labeled 105), and processor stepping 2 (labeled 106). Components 103 and 104 may be any of various different types of components commonly implemented in a system, such as processors (as with processor components 105 and 106), data storage devices (e.g., memory), controllers, operating system (OS), or other hardware components or software applications. Also, various other components (instead of or in addition to example components 103-106) may be implemented in system 100.

In the example embodiment of FIG. 1, component compatibility structure 102 is also implemented in system 100 such that it is accessible by system firmware 101. In one embodiment, component compatibility structure 102 is implemented in non-volatile memory (e.g., NVRAM) of system 100. As described further below, in operation of certain embodiments of the present invention, system firmware 101 is operable to discover components 101-106 of system 100 during the system's boot-up process, and system firmware 101 accesses compatibility structure 102 to determine whether the mix of discovered components are compatible with each other. Various example implementations of compatibility structure 102 are described hereafter in conjunction with FIGS. 2, 3A-3B, and 4.

Further, in this example, interface 102A of compatibility structure 102 is provided. Such interface 102A may enable a user (e.g., service technician, system administrator, etc.) to access (e.g., edit) compatibility structure 102 via, for example, input/output (I/O) devices 107, which may include a keyboard, pointing device (e.g., mouse, trackball, etc.), and/or other input devices, a display, printer, and/or other output devices. Interface 102A may be implemented in any suitable manner, including without limitation a command line interface (e.g., implemented in system firmware 101). As described further below, in certain embodiments, security measures may be implemented to prevent unauthorized access of compatibility structure 102. For instance, an authorized security code (e.g., password) may be required by interface 102A before allowing a user access to compatibility structure 102.

As further shown in the example of FIG. 1, in certain embodiments, system 100 may be communicatively coupled to server 109 via communication network 108. Accordingly, information may be downloaded to compatibility structure 102 from server 109 via communication network 108 in certain embodiments, as described further below. It should be recognized that communication network 108 may comprise, as examples, the Internet or other Wide Area Network (WAN), an Intranet, Local Area Network (LAN), wireless network, Public (or private) Switched Telephony Network (PSTN), a combination of the above, or any other communications network now known or later developed within the networking arts that permits two or more computing devices to communicate with each other. It should also be recognized that server 109 may comprise any processor-based device communicatively coupled to communication network 108 and operable to communicate compatibility information to structure 102.

Turning to FIG. 2, an example compatibility structure that may be implemented in embodiments of the present invention is shown. More specifically, in this example, the compatibility structure comprises a matrix identifying whether each of three components (component 1, component 2, and component 3) is compatible with the other of the three components. The example matrix of FIG. 2 is arranged such that the first column corresponds to component 1, the second column corresponds to component 2, and the third column corresponds to component 3. Also, the first row of the matrix corresponds to component 1, the second row corresponds to component 2, and the third row corresponds to component 3. A cell of the matrix identifies whether the corresponding components of its column and row are compatible with each other. For instance, the cell in the first row, second column identifies whether component 1 (corresponding to the first row) and component 2 (corresponding to the second column) are compatible with each other.

In the example of FIG. 2, a “0” is used to indicate that the corresponding components of a cell are compatible with each other, and a “1” is used to indicate that the corresponding components of a cell are not compatible with each other. Of course, in alternative implementations any suitable type of information may be used in the compatibility structure to indicate whether components are compatible with each other. Generally, components are designed to be compatible with further like components. For instance, a given processor is generally compatible for being implemented in a system with other of such given processors. Accordingly, in the example of FIG. 2, the cell of column 1, row 1 is populated with “0” indicating that component 1 is compatible with other of such component 1s. Similarly, the cell of column 2, row 2 is populated with “0” indicating that component 2 is compatible with other of such component 2s, and column 3, row 3 is populated with “0” indicating that component 3 is compatible with other of such component 3s.

Additionally, in the example of FIG. 2 various other mixes of components are indicated as being compatible, such as the mix of component 1 with component 2 (see the cell of column 2, row 1 or the cell of column 1, row 2). However, in this example, the mix (or combination) of component 1 and component 3 is identified as being incompatible. More specifically, the cell of column 1, row 3 and the cell of column 3, row 1 each correspond to the combination of components 1 and 3, and each of these cells have been populated with “1” indicating that this combination of components is incompatible for this system. While this example implements a full matrix that comprises duplicative information (e.g., the cells of column 1, row 3 and column 3, row 1 each provide the same information, i.e., an indication of whether components 1 and 3 are compatible with each other), alternative embodiments may implement a matrix (or other mapping structure) that does not include such duplicative information. For instance, a mapping structure (e.g., matrix) may be implemented in certain embodiments that comprises a single cell for each combination of components to conserve memory.

In operation of certain embodiments of the present invention, during the boot-up process of a system, system firmware 101 discovers the components of the system and accesses compatibility structure 102 to determine whether the mix of discovered components is compatible. In the example of FIG. 2, if components 1 and 3 were discovered in the system, then firmware 101 would determine from the compatibility structure (e.g., matrix) that this combination of components is not compatible and would issue a warning to this effect.

Further, in accordance with embodiments of the present invention, upon a new component being released, the new component's compatibility with other components may be determined and the compatibility structure updated to reflect the compatibility of the newly released component with various other components. For instance, upon a fourth component being released in the example of FIG. 2, an additional row and column may be added to the matrix for identifying the compatibility of such fourth component with components 1-3. Once such compatibility structure (e.g., matrix) is so modified, system firmware 101 is operable to use that structure to determine the compatibility of the newly released fourth component with components 1-3 in the event that the newly released fourth component in combination with one or more of components 1-3 is discovered by firmware 101 as being implemented within system 100. Accordingly, the ability of firmware 101 to determine the compatibility of such newly released component with a combination of other components may be added without requiring any modification (e.g., re-installation) of firmware 101. Thus, compatibility structure 102 may be updated from time to time to effectively impart new knowledge regarding compatibility of various mixes of components to firmware 101 without requiring any modification to firmware 101.

Turning now to FIGS. 3A-3B, a further example of implementing compatibility structure 102 in accordance with an embodiment of the present invention is shown. In the example of FIGS. 3A-3B, an index matrix is provided (in FIG. 3A) that maps various different components (different processor steppings in this example) to corresponding indexes. The indexes are then used in the compatibility matrix (of FIG. 3B) to identify whether various combinations of components identified by the indexes are compatible. For instance, the example index matrix of FIG. 3A includes a first column in which names (or other identifier) of a processor stepping is provided and a second column in which an index is assigned to the corresponding processor stepping. For instance, in row 1 of the index matrix, a processor stepping identified as “processor stepping 1” is assigned index “1”. Similarly, processor steppings identified as “processor stepping 2”, “processor stepping 3”, and “processor stepping 4” are assigned indexes 2, 3, and 4, respectively, in the example of FIG. 3A.

In certain embodiments, the index matrix of FIG. 3A may be implemented in non-volatile memory (e.g., NVRAM) as a circular queue, for example. Thus, as new components are released they can be added within the index matrix. Further, as older components in the index matrix become outdated (and no longer commonly implemented in systems), the entry for those components in the index matrix may be overwritten for insertion of new components in certain embodiments. Of course, in other embodiments, the size of such index matrix may grow with each new release of a component without ever overwriting a previously inserted entry.

In operation, system firmware discovers a component (e.g., a processor stepping in the example of FIG. 3A) during the system boot-up process. Generally, a processor, for example, includes information that is provided to the system firmware during the boot-up process identifying the processor stepping. Thus, as the system firmware receives the information identifying the processor stepping of each discovered processor in the system, it accesses the index matrix of FIG. 3A to determine the corresponding index assigned to such processor stepping. Then, as described below, the system firmware accesses the compatibility matrix of FIG. 3B and uses the indexes assigned to the discovered processor steppings to determine whether those processor steppings are compatible with each other.

FIG. 3B shows an example compatibility matrix for the components of FIG. 3A, in which the indexes assigned to the components in FIG. 3A are used to represent those components in the matrix of FIG. 3B. Thus, the compatibility matrix of FIG. 3B includes information identifying whether each of the four processor steppings 1-4 is compatible with the other of the four processor steppings. The example matrix of FIG. 3B is arranged such that the first column corresponds to index 1 (which corresponds to “processor stepping 1” according to the index matrix of FIG. 3A), the second column corresponds to index 2 (which corresponds to “processor stepping 2” according to the index matrix of FIG. 3A), the third column corresponds to index 3 (which corresponds to “processor stepping 3” according to the index matrix of FIG. 3A), and the fourth column corresponds to index 4 (which corresponds to “processor stepping 4” according to the index matrix of FIG. 3A). Also, the first row of the matrix corresponds to index 1, the second row corresponds to index 2, the third row corresponds to index 3, and the fourth row corresponds to index 4.

As with the example compatibility matrix of FIG. 2, a “0” is used to indicate that the corresponding processor steppings of a cell are compatible with each other, and a “1” is used to indicate that the corresponding processor steppings of a cell are not compatible with each other. Generally, processor steppings are designed to be compatible with further like processor steppings. For instance, a given processor stepping is generally compatible for being implemented in a system with other of such processors of this stepping. Accordingly, in the example of FIG. 3B, the cell of column 1, row 1 is populated with “0” indicating that processor stepping 1 is compatible with other of such processor stepping 1s. Similarly, the cell of column 2, row 2 is populated with “0” indicating that processor stepping 2 is compatible with other of such processor stepping 2s; column 3, row 3 is populated with “0” indicating that processor stepping 3 is compatible with other of such processor stepping 3s; and column 4, row 4 is populated with “0” indicating the processor stepping 4 is compatible with other of such processor stepping 4s.

Additionally, in the example of FIG. 3B various other mixes of processor steppings are indicated as being compatible, such as the mix of processor stepping I with processor stepping 2 (see the cell of column 2, row 1 or the cell of column 1, row 2). However, in this example, the mix (or combination) of processor stepping 1 and processor stepping 4 is identified as being incompatible. More specifically, the cell of column 1, row 4 and the cell of column 4, row 1 each correspond to the combination of processor stepping 1 and processor stepping 4, and each of these cells have been populated with “1” indicating that this combination of processor steppings is incompatible for this system. Also, in this example, the mix (or combination) of processor stepping 2 and processor stepping 4 is identified as being incompatible. More specifically, the cell of column 2, row 4 and the cell of column 4, row 2 each correspond to the combination of processor stepping 2 and processor stepping 4, and each of these cells have been populated with “1” indicating that this combination of processor steppings is incompatible for this system.

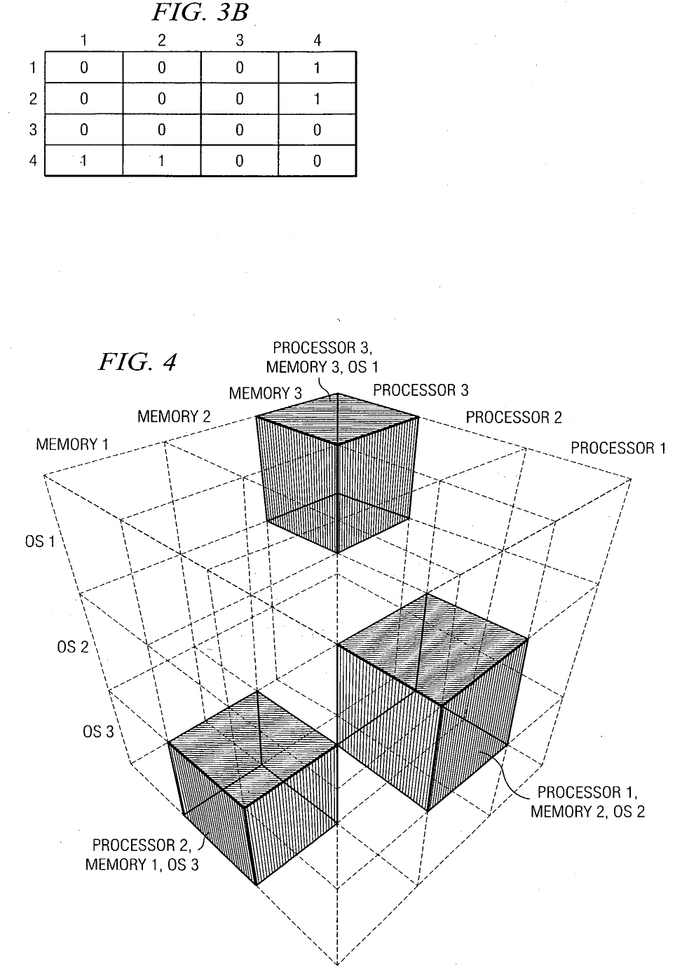

While in the above examples of FIGS. 2 and 3B each cell of a matrix indicates whether two components of a system are compatible, in other embodiments this implementation may be expanded such that each cell of a matrix indicates whether any number of components are compatible with one another. For instance, turning to FIG. 4, a further example of implementing compatibility structure 102 in accordance with an embodiment of the present invention is shown. The example compatibility structure of FIG. 4 comprises a three-dimensional (3D) matrix in which each cell of the matrix contains information identifying whether three components of a system are compatible with one another. More specifically, in the example of FIG. 4 a first dimension of the matrix corresponds to different processors (shown as Processor 1, Processor 2, and Processor 3), a second dimension of the matrix corresponds to different types of memory (shown as Memory 1, Memory 2, and Memory 3), and a third dimension of the matrix corresponds to different types of operating systems (shown as OS 1, OS 2, and OS 3).

Each cell of the matrix of FIG. 4 identifies whether the corresponding three components mapped to such cell are compatible with each other. For instance, the cell having a position in the 3D matrix that corresponds to Processor 1, Memory 1, and OS 1 identifies whether such Processor 1, Memory 1, and OS 1 are compatible with each other in a system. In the example of FIG. 4, an unshaded cell is used to indicate that its corresponding components are compatible with each other, and a shaded cell is used to indicate that the corresponding components of a cell are not compatible with each other. Of course, the mapping structure (e.g., data structure, etc.) actually used to implement the 3D compatibility structure of FIG. 4 may comprise any suitable type of information for indicating whether the components of each combination (e.g., Processor, Memory, and OS) are compatible with each other, such as using a “0” to indicate they are compatible and a “1” to indicate they are not compatible as in the above examples of FIGS. 2 and 3B.

In the example of FIG. 4, various mixes of components are indicated as being compatible, such as the mix of Processor 1, Memory 1, and OS 1. However, in this example, the mix (or combination) of Processor 1, Memory 2, and OS 2 is identified as being incompatible. More specifically, the cell corresponding to Processor 1, Memory 2, and OS 2 has been shaded (or otherwise populated with information) indicating that this combination of components is incompatible for this system. Further, the mix (or combination) of Processor 2, Memory 1, and OS 3 is identified as being incompatible (i.e., the cell of the matrix corresponding to these components is shaded or otherwise populated with information indicating that this combination of components is incompatible for this system). Also, the mix (or combination) of Processor 3, Memory 3, and OS 1 is identified as being incompatible (i.e., the cell of the matrix corresponding to these components is shaded or otherwise populated with information indicating that this combination of components is incompatible for this system). Thus, as shown by the example of FIG. 4, certain embodiments of the present invention may be implemented to enable identification of the compatibility between any number of different components that may be implemented within a system.

It should be understood that while example two-dimensional and three-dimensional matrices are shown in the above examples of compatibility structures shown in FIGS. 2, 3B, and 4, any other suitable mapping structure now known or alter developed may be utilized in accordance with embodiments of the present invention. For instance, tables, data structures, or any other suitable technique for mapping various components to information identifying their compatibility with one another may be employed in certain embodiments of the present invention.

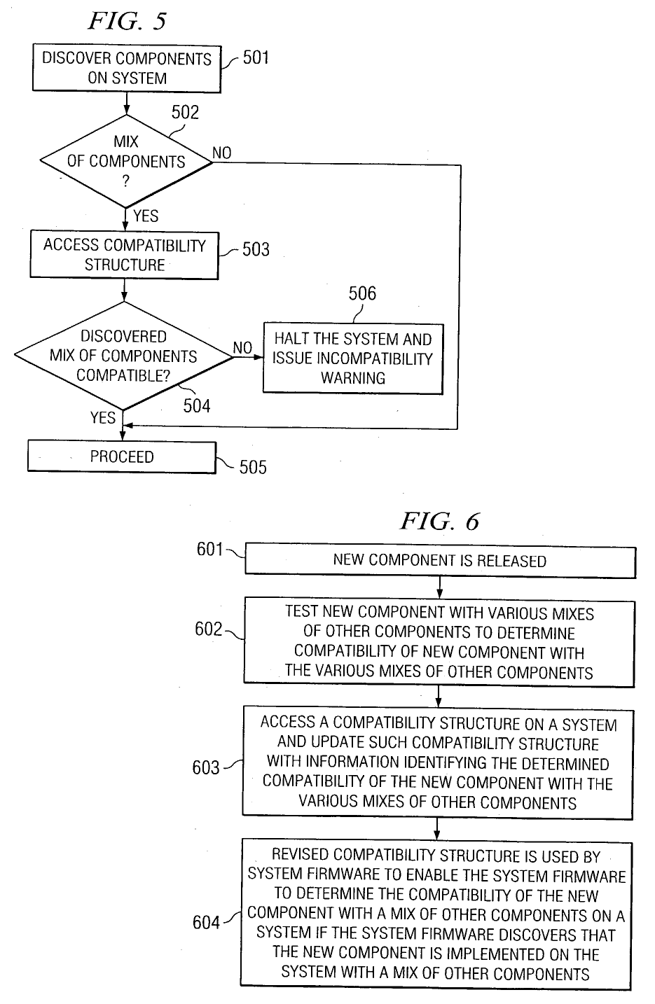

Turning to FIG. 5, an example operational flow diagram illustrating the operation of one embodiment of the present invention is shown. In operational block 501, the components implemented on a system are discovered. For instance, generally firmware 101 (of FIG. 1) discovers the components implemented on system 100 during the boot-up process of system 100. In block 502, it may be determined whether a mix of components is discovered. For instance, as described above, generally components are implemented such that they are compatible with further implementations of like components (e.g., multiple processors implemented on a system that are all of the same processor stepping are generally compatible with each other). Thus, in certain implementations the compatibility structure may be accessed to determine whether components are compatible upon a mix (or combination) of different components (e.g., processors of different steppings) are discovered. For instance, in the example of FIG. 5, if it is determined at block 502 that the system does not include a mix of components (e.g., the system comprises multiple processors all of the same stepping), then operation advances to block 505 to proceed with the boot-up process. However, if it is determined at block 502 that the system includes a mix of components, then operation advances to block 503 as discussed further below. It should be understood that in certain implementations operational block 502 may be eliminated from the flow, and operation may proceed to block 503 irrespective of whether a mix of components is discovered on the system.

In operational block 503, a compatibility structure implemented on the system is accessed. For instance, referring to the example system of FIG. 1, compatibility structure 102 may be accessed by firmware 101. In operational block 504, it is determined, based at least in part on information included in the compatibility structure, whether the discovered mix of components are compatible. That is, system firmware 101 may determine from the information contained in compatibility structure 102 whether the discovered mix of components of system 100 (e.g., the different processor steppings and/or mix of other components) is compatible. If the mix of components is determined to be compatible, then operation advances to block 505 to proceed with the boot-up process of the system. If, on the other hand, the mix of components is determined to be incompatible, then operation advances to block 506 whereat a warning of the incompatibility is issued. For instance, at block 506, system firmware 101 may halt the boot-up process of system 100 (i.e., not allow it to boot-up) and may generate a warning message on the system's display indicating that components of the system have been determined to be incompatible with each other.

As described above, one advantage of certain embodiments of the present invention is that information may be supplied to an editable compatibility structure regarding the compatibility of newly released components (e.g., a new processor stepping), and system firmware may be operable to use the compatibility structure such that the firmware is not required to be modified to be capable of determining the compatibility of a newly released component. That is, to expand the components for which the firmware is operable to determine the compatibility of mixes (or combinations) thereof, the compatibility structure may be modified without requiring modification (e.g., re-installation) of the system firmware itself.

Turning to FIG. 6, an example operational flow diagram is shown for updating a compatibility structure such that system firmware can check for the compatibility of a newly released component with mixes of other components. In operational block 601, a new component is released. For example, a new processor stepping may be released by a processor developer. In operational block 602, the new component is tested with various mixes of other components that may be implemented within a given system to determine the compatibility of the new component with such various mixes of other components for the system. For example, a new processor stepping may be tested for its compatibility with various other processor steppings implemented on a system.

In operational block 603, a compatibility structure implemented on a system, such as compatibility structure 102 of FIG. 1, is accessed and is updated (e.g., edited) to include information identifying the determined compatibility of the new component with the various mixes of other components. In certain implementations, a user (e.g., system administrator or service technician) may access the compatibility structure and edit it to provide the new compatibility information. For instance, with reference to the example system of FIG. 1, a user may use input/output (I/O) device(s) 107 to update compatibility structure 102 via interface 102A. Of course, security measures may be implemented by interface 102A to ensure that the user is authorized to edit such compatibility structure 102 (e.g., a password or other type of authentication technique may be required of the user attempting to access compatibility structure 102 to ensure that the user is authorized to edit the structure).

In other implementations, the new compatibility information may be downloaded from a server computer to the compatibility structure of a system via a communication network. For instance, with reference again to the example system of FIG. 1, the determined compatibility information (from the testing of operational block 602) may be downloaded from server 109 to compatibility structure 102 via communication network 108. Again, a security measure may be implemented to ensure that server 109 is authorized to download information to compatibility structure 102. As an example, the system administrator of system 100 may access server 109 (which may be implemented as a Web server or other type of processor-based device to which system 100 may at least temporarily communicatively couple via communication network 108) and request the latest compatibility structure for his/her system (or latest update for such structure) be downloaded thereto. As another example, system 100 may be implemented to periodically access server 109 (automatically) and request the latest compatibility structure for such system (or latest update for such structure) be downloaded thereto.

Returning to FIG. 6, once the compatibility structure is updated with the compatibility information for the new component in block 603, the revised compatibility structure may be used by the system firmware in operational block 604. That is, the system firmware may use the revised compatibility structure to determine the compatibility of the new component with a mix of other components on the system if the system firmware discovers that such new component is implemented on the system with a mix of other components. Accordingly, the system firmware is operable to determine the compatibility of the new component with a mix of other components that may be discovered on a system without requiring any modification to the system firmware.

It should be recognized that while various types of components, such as processor steppings, memory, and operating systems are used in the above examples, embodiments of the present invention may be implemented for determining the compatibility of any type of components that may be implemented on a system and thus are not limited to the specific examples provided herein. For instance, as described above, certain embodiments of the present invention utilize a compatibility structure that is editable to include information specifying the compatibility of any number of different components, and system firmware may be used (e.g., during the boot-up process of a system) to determine based at least in part on information in the compatibility structure whether a mix (or combination) of components implemented on a system are compatible.

As also described above, in certain embodiments, such compatibility structure is modifiable (or editable) independent of the system firmware. That is, the compatibility structure may be edited without being required to modify (and/or re-install) the system firmware. As described above, such compatibility structure is implemented external to the system firmware in certain embodiments, and thus the system firmware need not be modified in order to modify the compatibility structure (e.g., update the compatibility structure with new compatibility information). More particularly, the system firmware may make use of modified information in the compatibility structure for making a determination as to the compatibility of components discovered on a system without requiring that such system firmware itself be modified for making the determination. For instance, the compatibility structure may be edited to include new information about the compatibility of a newly released component with other components that may be found on a system, and the pre-existing system firmware may make use of such new information to determine the compatibility of the newly released component with other components (in the event that such newly released component is discovered by the firmware as implemented on the system) without requiring that the system firmware be modified to make that compatibility determination. In certain embodiments, the system firmware is stored to a first portion of non-volatile memory and the compatibility structure is stored to a second portion of non-volatile memory that is different from the first portion, wherein the compatibility structure is editable independent of the system firmware (i.e., without requiring editing of the system firmware) and the system firmware is capable of communicatively accessing the compatibility structure for determining the compatibility of components implemented on a system with each other.

When implemented via computer-executable instructions, various elements of embodiments of the present invention are in essence the software code defining the operations of such various elements. The executable instructions or software code may be obtained from a computer-readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, computer-readable media can include any medium that can store or transfer information. As described above, such software code may be stored to a computer-readable medium included within the system firmware to enable the system firmware to determine the compatibility of components implemented on a system.

What is claimed is:

1. A method comprising:
identifying a plurality of components on a system;
accessing with system firmware a compatibility structure that includes information indicating whether each of the plurality of components are compatible with each other, wherein said compatibility structure is arranged external to said system firmware; and
determining with said system firmware based at least in part on said information of said compatibility structure whether said identified plurality of components are compatible with each other.

2. The method of claim 1 further comprising:
editing said compatibility structure to include additional information regarding compatibility of a mix of components.

3. The method of claim 2 wherein said determining based at least in part on said additional information being performed without modification to said system firmware.

4. The method of claim 2 wherein said editing to include additional information regarding compatibility of a mix of components comprises including information identifying whether a newly released component is compatible with said plurality of components.

5. The method of claim 4 wherein said determining when said newly released component is included in said identified plurality of components on said system being performed without modification to said system firmware.

6. The method of claim 1 wherein said identifying a plurality of components comprises identifying a mix of different processor steppings.

7. The method of claim 6 wherein said accessing comprises accessing said compatibility structure comprising information indicating whether a plurality of different processor steppings are compatible with each other.

8. A system comprising:
means for identifying, during a boot-up process of a system, a mix of components implemented on said system;
means for storing compatibility information indicating whether a plurality of different mixes of components are compatible with each other; and
means for determining, based at least in part on said compatibility information, whether said mix of components identified by the identifying means are compatible with each other, wherein said compatibility information of said compatibility structure is modifiable without requiring modification to said means for determining.

9. The system of claim 8 further comprising:
means for enabling editing of said compatibility information.

10. The system of claim 9 wherein said means for enabling editing enables said editing of said compatibility information independent of modifying said means for determining.

11. The system of claim 8 wherein said mix of components identified on said system comprise a mix of different processor steppings.

12. The system of claim 11 wherein said compatibility information comprises information indicating whether each of a plurality of different mixes of processor steppings are compatible.

13. A system comprising:
firmware stored to a first portion of non-volatile memory and operable to discover a plurality of different components implemented on a computer system;
a compatibility structure stored to a second portion of non-volatile memory different from said first portion and communicatively accessible by said firmware, wherein said compatibility structure comprises information indicating whether different components are compatible with each other; and
said firmware further operable to determine, based at least in part on said information of said compatibility structure, whether said plurality of different components discovered by said firmware are compatible with each other.

14. The system of claim 13 further comprising:
an interface to said compatibility structure that enables editing of said information.

15. The system of claim 14 wherein said interface enables said editing of said information independent of modifying said firmware.

16. The system of claim 14 wherein said editing of said information comprises adding additional information to said compatibility structure.

17. The system of claim 16 wherein said additional information comprises information identifying whether a newly released component is compatible with said different components.

18. The system of claim 16 wherein said firmware is not required to be modified to be operable to determine, based at least in part on said additional information of said compatibility structure, whether said plurality of different components discovered by said firmware are compatible with each other.

19. The system of claim 13 wherein said plurality of different components discovered by said firmware comprise a mix of different processor steppings.

20. The system of claim 19 wherein said information indicating whether different components are compatible with each other comprises information indicating whether a plurality of different processor steppings are compatible with each other.

21. Computer-executable software code stored to a computer-readable media, said computer-executable software code comprising:
code for identifying a plurality of components on a system;
code included in system firmware for accessing a compatibility structure that includes information indicating whether each of the plurality of components are compatible with each other, wherein said compatibility structure is arranged external to said system firmware; and
code included in said system firmware for determining based at least in part on said information of said compatibility structure whether said identified plurality of components are compatible with each other.

22. The computer-executable software code of claim 21 wherein said code for identifying a plurality of components comprises code for identifying a mix of different processor steppings.

23. The computer-executable software code of claim 21 wherein said code for identifying is included in said system firmware.

24. A method for preventing a new component from causing compatibility errors on at least one existing computer system in which it is used, said method comprising:
testing the new component for compatibility with mixes of other components;
using results of the testing to generate compatibility information indicative of any incompatible combinations of the new component and the mixes of other components, the compatibility information being useable by firmware of the computer to preclude computer operation in any of said incompatible combinations; and
making the compatibility information accessible to said firmware of the computer system without modification to the firmware.

25. The method of claim 24 wherein making the compatibility information accessible comprises uploading the compatibility information to an existing data structure currently accessible by the firmware.
